(19) United States
(12) Patent Application Publication
(10) Pub. No.: US 2022/0113260 A1
(43) Pub. Date: Apr. 14, 2022

(54) IMAGE PROCESSING APPARATUS

(71) Applicant: NEC Corporation, Minato-ku, Tokyo (JP)

(72) Inventor: Asuka ISHII, Tokyo (JP)

(73) Assignee: NEC Corporation, Minato-ku, Tokyo (JP)

(21) Appl. No.: 17/426,838

(22) PCT Filed: Feb. 1, 2019
(86) PCT No.: PCT/JP2019/003696

§ 371 Date: Jul. 29, 2021

(51) Int. Cl. G01N 21/88; G06V 10/24; G01B 11/30

(52) U.S. Cl. CPC G01N 21/8851; G06V 10/24; G01N 2021/8893; G01N 2021/8864; G01B 11/30

(57) ABSTRACT

An image processing apparatus includes a dividing unit, a measuring unit, a comparing unit, and a determining unit. The dividing unit spatially divides a time-series image of a structure surface captured during passage of a traffic load into a plurality of partial regions, and generates a plurality of partial time-series images. The measuring unit measures temporal changes in deflection amount of the structure surface in the respective partial regions from the plurality of partial time-series images. The comparing unit compares the temporal changes in deflection amount of the structure surface in the respective partial regions. The determining unit determines an orientation of the time-series image with respect to a passage direction of the traffic load based on a result of the comparison.

### TECHNICAL FIELD

The present invention relates to an image processing apparatus that determines the orientation of a captured image, an image processing method, and a recording medium.

### BACKGROUND ART

Various techniques of analyzing an image of a structure such as a bridge captured by an image capture device and diagnosing the soundness of the structure have been proposed (see, for example, Patent Document 1).

Patent Document 1: WO2016/152076

The soundness of a large-scale structure such as a bridge is diagnosed by setting a plurality of diagnosis spots and analyzing images of the respective diagnosis spots captured by an image capture device. The diagnosis of the same structure may be performed repeatedly in a cycle such as once every few months. In the case of thus capturing a plurality of diagnosis spots at the same time or at different times, it is general to align the orientations of the captured images of all the diagnosis spots for the convenience of comparison of diagnosis results and so on. However, in a situation such that the floor deck of a bridge or the like is captured from below, it is difficult to determine the orientation of a captured image from the captured image. The reason is that a subject such as a shape or a pattern that can specify the orientation of an image often does not exist in a subject such as a floor deck.

### SUMMARY

An object of the present invention is to provide an image processing apparatus which solves the abovementioned problem, that is, a problem that when a subject such as a shape or a pattern that can specify the orientation of an image is not shown in the image, it is difficult to determine the orientation of the image from the image.

An image processing apparatus according to an aspect of the present invention includes: a dividing unit configured to spatially divide a time-series image of a structure surface captured during passage of a traffic load into a plurality of partial regions, and generate a plurality of partial time-series images; a measuring unit configured to measure temporal changes in deflection amount of the structure surface in the respective partial regions from the plurality of partial time-series images; a comparing unit configured to compare the temporal changes in deflection amount of the structure surface in the respective partial regions; and a determining unit configured to determine an orientation of the time-series image with respect to a passage direction of the traffic load based on a result of the comparison.

An image processing method according to another aspect of the present invention includes: spatially dividing a time-series image of a structure surface captured during passage of a traffic load into a plurality of partial regions, and generating a plurality of partial time-series images; measuring temporal changes in deflection amount of the structure surface in the respective partial regions from the plurality of partial time-series images; comparing the temporal changes in deflection amount of the structure surface in the respective partial regions; and determining an orientation of the time-series image with respect to a passage direction of the traffic load based on a result of the comparison.

On a non-transitory computer-readable recording medium according to another aspect of the present invention, a computer program is recorded. The computer program includes instructions for causing a computer to execute: a process of spatially dividing a time-series image of a structure surface captured during passage of a traffic load into a plurality of partial regions, and generating a plurality of partial time-series images; a process of measuring temporal changes in deflection amount of the structure surface in the respective partial regions from the plurality of partial time-series images; a process of comparing the temporal changes in deflection amount of the structure surface in the respective partial regions; and a process of determining an orientation of the time-series image with respect to a passage direction of the traffic load based on a result of the comparison.

With the configurations described above, the present invention enables determination of an orientation in which an image faces based on the image even if a subject such as a shape or a pattern that can specify the orientation of the image is not shown in the image.

### BRIEF DESCRIPTION OF DRAWINGS

FIG. 1 is a view showing a configuration example of a diagnostic apparatus according to a first example embodiment of the present invention;

FIG. 2 is a block diagram showing an example of a configuration of a computer in the diagnostic apparatus according to the first example embodiment of the present invention;

FIG. 3 is a view showing an example of a format of diagnosis spot information stored in a diagnosis spot database of the computer in the diagnostic apparatus according to the first example embodiment of the present invention;

FIG. 4 is a view showing an example of a format of diagnosis result information stored in a diagnosis result database of the computer in the diagnostic apparatus according to the first example embodiment of the present invention;

FIG. 5 is a flowchart showing an example of an operation of the diagnostic apparatus according to the first example embodiment of the present invention;

FIG. 6 is a view showing an example of an initial screen displayed on a screen display unit of the diagnostic apparatus according to the first example embodiment of the present invention;

FIG. 7 is a flowchart showing an example of first diagnosis processing executed by the computer in the diagnostic apparatus according to the first example embodiment of the present invention;

FIG. 8 is a view showing an example of a first diagnosis screen displayed on the screen display unit of the diagnostic apparatus according to the first example embodiment of the present invention;

FIG. 9 is a flowchart showing an example of continued diagnosis processing executed by the computer in the diagnostic apparatus according to the first example embodiment of the present invention;

FIG. 10 is a view showing an example of a diagnosis spot selection screen displayed on the screen display unit of the diagnostic apparatus according to the first example embodiment of the present invention;

FIG. 11 is a view showing an example of a capture position and capture direction guide screen displayed on the screen display unit of the diagnostic apparatus according to the first example embodiment of the present invention;

FIG. 12 is a flowchart showing details of an operation of creating and displaying the capture position and capture direction guide screen by the diagnostic apparatus according to the first example embodiment of the present invention;

FIG. 13 is a view showing a configuration example of an image orientation determination unit in the diagnostic apparatus according to the first example embodiment of the present invention;

FIG. 14 is a view showing an example of a relation between a time-series image before division and a partial time-series image after division in the first example embodiment of the present invention;

FIG. 15 is a schematic view showing an example of a temporal change in deflection amount of a partial region of the partial time-series image in the first example embodiment of the present invention;

FIG. 16 is a graph showing an example of temporal changes in deflection amount of two partial regions in the first example embodiment of the present invention;

FIG. 17 is a graph showing an example of a temporal change in difference between the deflection amounts of the two partial regions in the first example embodiment of the present invention;

FIG. 18 is a view showing an arrangement status of an upper left block, a lower left block, an upper right block and a lower right block when a lateral direction of a captured image is parallel to a bridge axis direction in the first example embodiment of the present invention;

FIG. 19 is a view showing a variation in temporal change in deflection amount of the partial region of the partial time-series image in the first example embodiment of the present invention;

FIG. 20 is a graph showing an example of a temporal change in difference between deflection amounts of two blocks arranged parallel to the bridge axis direction in the first example embodiment of the present invention;

FIG. 21 is a graph showing an example of a temporal change in difference between deflection amounts of two blocks arranged perpendicular to the bridge axis direction in the first example embodiment of the present invention;

FIG. 22 is a view showing an arrangement status of the upper left block, the lower left block, the upper right block and the lower right block when the lateral direction of the captured image is perpendicular to the bridge axis direction in the first example embodiment of the present invention;

FIG. 23 is a view showing an arrangement status of the upper left block, the lower left block, the upper right block and the lower right block when the lateral direction of the captured image tilts 45 degrees clockwise with respect to the bridge axis direction in the first example embodiment of the present invention;

FIG. 24 is a view showing an arrangement status of the upper left block, the lower left block, the upper right block and the lower right block when the lateral direction of the captured image tilts 45 degrees counterclockwise with respect to the bridge axis direction in the first example embodiment of the present invention; and

FIG. 25 is a block diagram of an image processing apparatus according to a second example embodiment of the present invention.

### EXAMPLE EMBODIMENTS

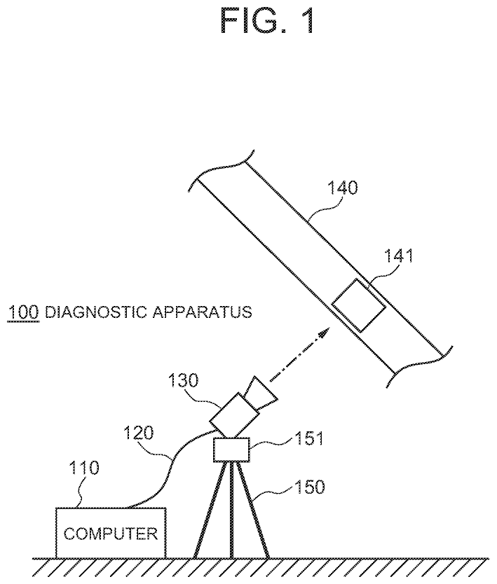

FIG. 1 is a view showing a configuration example of a diagnostic apparatus 100 according to a first example embodiment of the present invention. Referring to FIG. 1, the diagnostic apparatus 100 includes a computer 110, and a camera 130 connected to the computer 110 via a cable 120.

The camera 130 is an image capture device that captures a region 141 existing on the surface of a structure 140 to be diagnosed at a predetermined frame rate. The structure 140 is a bridge in this example embodiment. The region 141 is a part of a floor deck to be a diagnosis spot of the bridge. However, the structure 140 is not limited to a bridge. The structure 140 may be an elevated structure of an expressway or a railway. The size of the region 141 is, for example, several tens of centimeters square. The camera 130 is attached to a pan head 151 on a tripod 150 so that the capture direction of the camera can be fixed in any direction. The camera 130 may be, for example, a high-speed camera that includes a CCD (Charge-Coupled Device) image sensor or a CMOS (Complementary MOS) image sensor having pixel capacity of about several million pixels. Moreover, the camera 130 may be a black and white camera, or may be an infrared camera or a color camera. The camera 130 also includes a GPS receiver that measures the position of the camera. The camera 130 also includes an orientation sensor and an acceleration sensor that measure the capture direction of the camera.

The computer 110 has a diagnostic function of importing an image of the structure 140 captured by the camera 130, performing predetermined image processing to determine the soundness of the structure 140, and outputting the determination result. Moreover, the computer 110 has a guide function of assisting an operator to be able to capture the same region 141 of the structure 140 in the same orientation from the same image capture position in each diagnosis performed in a predetermined cycle such as once every few months.

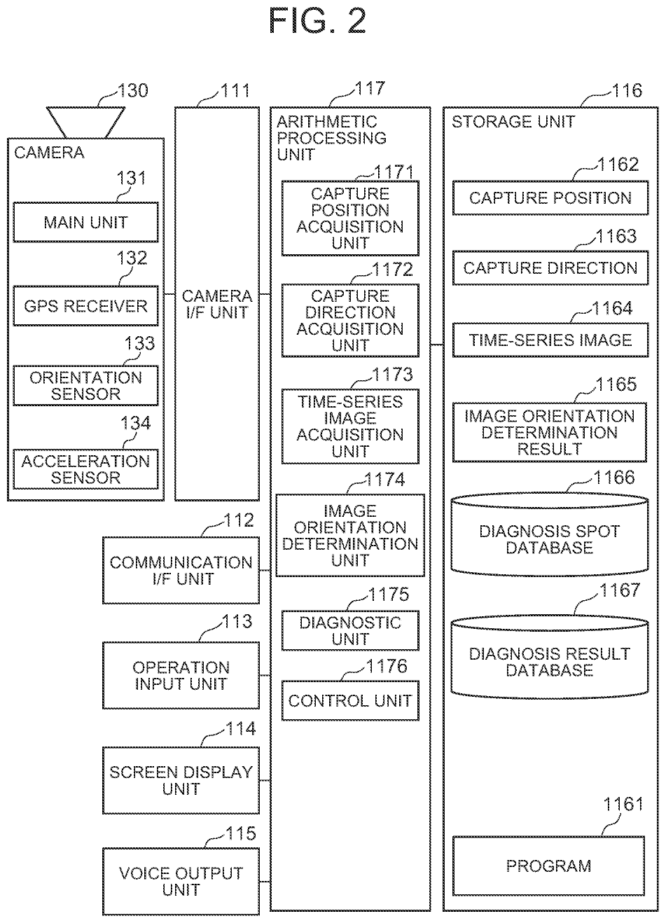

FIG. 2 is a block diagram showing an example of a configuration of the computer 110. Referring to FIG. 2, the computer 110 includes a camera I/F (interface) unit 111, a communication I/F unit 112, an operation input unit 113, a screen display unit 114, a voice output unit 115, a storage unit 116, and an arithmetic processing unit 117.

The camera I/F unit 111 is connected to the camera 130 via the cable 120, and is configured to perform transmission and reception of data with the camera 130 and the arithmetic processing unit 117. The camera 130 includes a main unit 131 including an image sensor and an optical system, and also includes a GPS receiver 132, an orientation sensor 133, and an acceleration sensor 134 that are mentioned before. The camera I/F unit 111 is configured to perform transmission and reception of data with the main unit 131, GPS receiver 132, orientation sensor 133 and acceleration sensor 134 and the arithmetic processing unit 117.

The communication I/F unit 112 is composed of a data communication circuit, and is configured to perform data communication with an external device (not shown) connected via wired or wireless communication. The operation input unit 113 is composed of an operation input device such as a keyboard and a mouse, and is configured to detect an operator's operation and output the detected operation to the arithmetic processing unit 117. The screen display unit 114 is composed of a screen display device such as an LCD (Liquid Crystal Display), and is configured to display on the screen various information such as a menu screen in response to an instruction from the arithmetic processing unit 117. The voice output unit 115 is composed of an acoustic output device such as a speaker, and is configured to output various voices such as a guide message in response to an instruction from the arithmetic processing unit 117.

The storage unit 116 is composed of a storage device such as a hard disk and a memory, and is configured to store processing information and a program 1161 that are necessary for various processing in the arithmetic processing unit 117. The program 1161 is a program loaded to and executed by the arithmetic processing unit 117 and thereby realizing various processing units. The program 1161 is previously stored from an external device or a recording medium that are not shown via a data input/output function such as the communication I/F unit 112, and stored into the storage unit 116. Major processing information stored in the storage unit 116 are a capture position 1162, a capture direction 1163, a time-series image 1164, an image orientation determination result 1165, a diagnosis spot database 1166, and a diagnosis result database 1167.

The capture position 1162 is data that includes latitude, longitude and altitude representing the position of the camera measured by the GPS receiver 132 and includes current time.

The capture direction 1163 is data showing the capture direction of the camera 130 calculated based on data measured by the orientation sensor 133 and the acceleration sensor 134 that are installed in the camera 130. The capture direction 1163 is composed of three angles of pitch, roll, and yaw that represent the attitude of the camera 130.

The time-series image 1164 is a time-series image captured by the camera 130. This time-series image 1164 may be a plurality of frame images composing a video of the region 141 of the structure 140 captured by the camera 130.

The image orientation determination result 1165 is data showing the orientation of a captured image determined based on the time-series image 1164. The orientation of a captured image represents, for example, a relation between the bridge axis direction of a bridge that is the structure 140 and the lateral direction of the captured image. It is needless to say that the orientation of a captured image is not limited to the above. For example, the orientation of a captured image may represent a relation between the bridge axis direction and the longitudinal direction of the captured image.

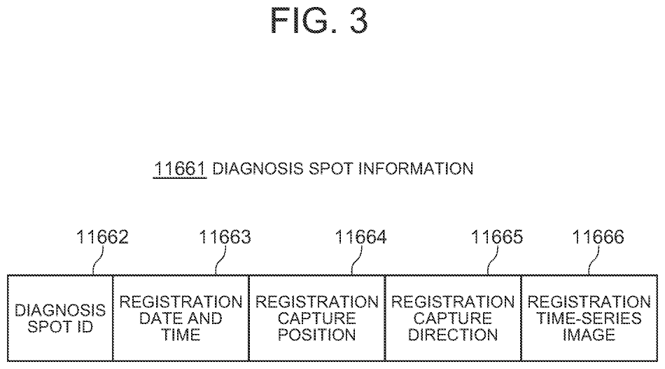

The diagnosis spot database 1166 is a storage unit in which information relating to a past diagnosis spot is stored. FIG. 3 shows an example of a format of diagnosis spot information 11661 stored in the diagnosis spot database 1166. The diagnosis spot information 11661 in this example includes a diagnosis spot ID 11662, a registration date and time 11663, a registration capture position 11664, a registration capture direction 11665, and a registration time-series image 11666.

The diagnosis spot ID 11662 is identification information that uniquely identifies a diagnosis spot. The registration date and time 11663 indicates a date and time when the diagnosis spot information 11661 is registered. The registration capture position 11664 indicates latitude, longitude, and altitude that show the position of the camera 130 at the time of diagnosis. The registration capture direction 11665 indicates three angles of pitch, roll, and yaw that show the attitude of the camera 130 at the time of diagnosis. The registration time-series image 11666 is a time-series image of the region 141 of the structure 140 captured by the camera 130 in the registration capture direction 11665 from the registration capture position 11664.

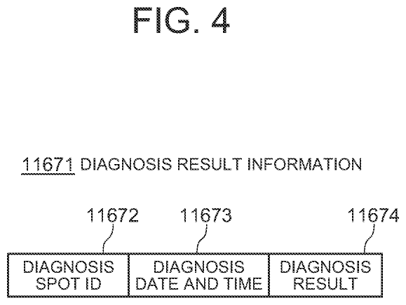

The diagnosis result database 1167 is a storage unit in which information relating to a diagnosis result is stored. FIG. 4 shows an example of a format of diagnosis result information 11671 stored in the diagnosis result database 1167. The diagnosis result information 11671 in this example includes a diagnosis spot ID 11672, a diagnosis date and time 11673, and a diagnosis result 11674. The diagnosis spot ID 11672 is identification information that uniquely identifies a diagnosis spot. The diagnosis date and time indicates a date and time of diagnosis. The diagnosis result 11674 is information showing the result of diagnosis.

The arithmetic processing unit 117 has a processor such as an MPU and a peripheral circuit thereof, and is configured to make the above hardware and the program 1161 cooperate and realize various processing units by loading the program 1161 from the storage unit 116 and executing. Major processing units realized by the arithmetic processing unit 117 are a capture position acquisition unit 1171, a capture direction acquisition unit 1172, a time-series image acquisition unit 1173, an image orientation determination unit 1174, a diagnostic unit 1175, and a control unit 1176.

The capture position acquisition unit 1171 is configured to regularly acquire the position of the camera 130 and the current time measured by the GPS receiver 132 through the camera I/F unit 111, and update the capture position 1162 of the storage unit 116 with the acquired position.

The capture direction acquisition unit 1172 is configured to regularly acquire an azimuth measured by the orientation sensor 133 and accelerations in three directions of the longitudinal, lateral and altitude directions measured by the acceleration sensor 134 through the camera I/F unit 111. The capture direction acquisition unit 1172 is also configured to calculate the attitude of the camera 130, that is, three angles of pitch, roll and yaw showing an image capture direction from the acquired azimuth and accelerations, and update the capture direction 1163 of the storage unit 116 with the calculation result. In this example embodiment, roll that shows a capture direction is calculated based on the azimuth acquired by the orientation sensor 133 and the accelerations in the three directions acquired by the acceleration sensor 134. However, as another example embodiment, roll that show a capture direction may be the orientation of an image determined by the image orientation determination unit 1174.

The time-series image acquisition unit 1173 is configured to acquire a time-series image captured by the camera 130 from the main unit 131 through the camera I/F unit 111, and update the time-series image 1164 of the storage unit 116 with the acquired time-series image. The time-series image acquisition unit 1173 is configured to acquire time-series images before and after at least one vehicle passes through the region 141 of the structure 140. For example, the time-series image acquisition unit 1173 may be configured to start acquiring a time-series image by an operator's instruction or by the output of a sensor (not shown) that mechanically detects a vehicle scheduled to pass before a vehicle passes through a bridge portion around the region 141, and finish acquiring the time-series image by an operator's instruction or by the output of a sensor (not shown) that mechanically detects a passing vehicle after a vehicle passes the bridge portion around the region 141. Alternatively, the time-series image acquisition unit 1173 may acquire a time-series image for a time of a time frame within which it is considered that at least one vehicle passes through the bridge, regardless of a timing when a vehicle passes through the bridge.

The image orientation determination unit 1174 is configured to determine the orientation of a captured image based on the time-series image 1164. The details of the image orientation determination unit 1174 will be described later.

The diagnostic unit 1175 is configured to perform a deterioration diagnosis of the structure 140 based on the image of the structure 140 captured by the camera 130. A method for deterioration diagnosis is not particularly limited. For example, the diagnostic unit 1175 is configured to analyze a video obtained by high-speed image capture of the region 141 of the structure 140 such as a bridge excited by the passage of a vehicle with the camera 130, measure vibrations of the surface, and estimate an internal deterioration status such as a crack, exfoliation or a cavity from the pattern of the vibrations. Moreover, the diagnostic unit 1175 is configured to store information relating to the estimated diagnosis result into the diagnosis result database 1167.

The control unit 1176 is configured to execute the main control of the diagnostic apparatus 100.

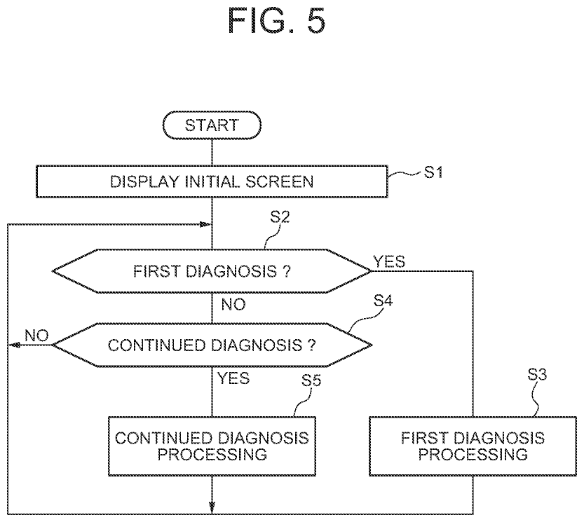

FIG. 5 is a flowchart showing an example of an operation of the diagnostic apparatus 100. Below, an operation of the diagnostic apparatus 100 when performing a deterioration diagnosis of the structure 140 will be described with reference to the drawings.

When an operator installs measurement devices such as the computer 110 and the camera 130 at sites in order to perform a deterioration diagnosis of the structure 140 and inputs an activation instruction from the operation input unit 113, control by the control unit 1176 is started.

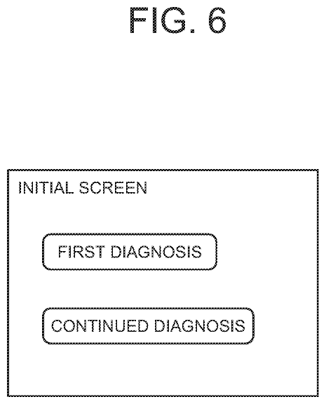

First, the control unit 1176 displays an initial screen as shown in FIG. 6 on the screen display unit 114 (step S1). On the initial screen, a first diagnosis button and a continued diagnosis button are displayed. The first diagnosis button is a button selected when a first diagnosis is performed on the structure 140 to be newly diagnosed. On the other hand, the continued diagnosis button is a button selected when second and subsequent diagnoses are performed on the same spot of the same structure 140. Below, an operation at the time of first diagnosis will be described, and then an operation at the time of continued diagnosis will be described.

### <First Diagnosis>

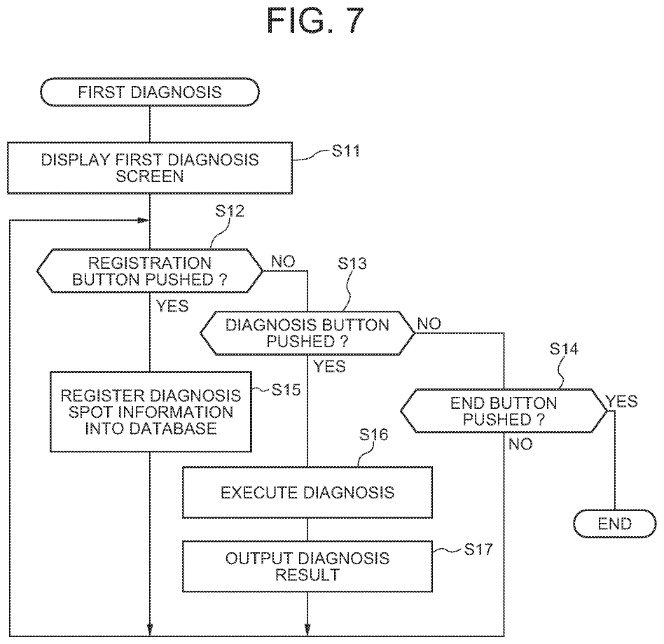

When the operator pushes the first diagnosis button on the initial screen, the control unit 1176 detects that (step S2), and executes first diagnosis processing (step S3). FIG. 7 is a flowchart showing an example of the first diagnosis processing. First, the control unit 1176 displays a first diagnosis screen on the screen display unit 114 (step S11).

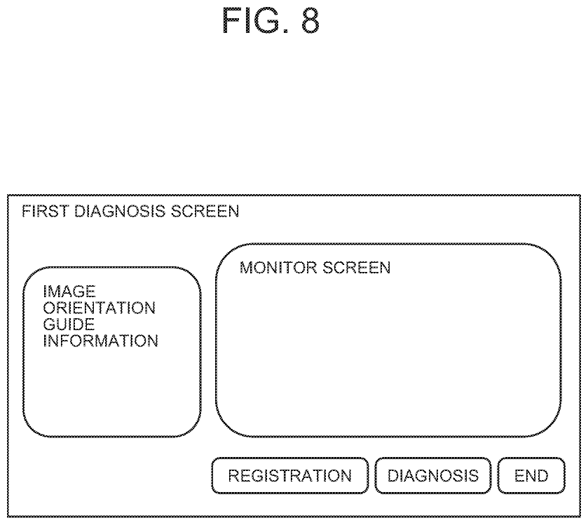

FIG. 8 shows an example of the first diagnosis screen. The first diagnosis screen in this example has a monitor screen that displays an image being captured by the camera 130, image orientation guide information, a registration button, a diagnosis button, and an end button. A latest time-series image being captured by the camera 130 is acquired by the captured image acquisition unit 1173 from the camera 130 and stored as the time-series image in the storage unit 116. The control unit 1176 acquires the time-series image 1164 from the storage unit 116 and displays on the monitor screen of the first diagnosis screen. The operator determines a diagnosis spot of the structure 140 and sets the determined diagnosis spot as the region 141. Then, the operator adjusts a place to install the tripod 150 so that an image of the region 141 is displayed in an appropriate size on the monitor screen of the first diagnosis screen. In this example embodiment, the angle of view and the magnification of the camera 130 are fixed. Therefore, when the image size of the region 141 is small, the operator increases the image size of the region 141 by moving the tripod 150 to a closer position to the structure 140. On the contrary, when the image size of the region 141 is large, the operator reduces the image size of the region 141 by moving the tripod 150 to a farther position from the structure 140.

Further, the control unit 1176 displays a text or an illustration figure that indicates to what degree the lateral direction of the captured image tilts with respect to the bridge axis direction of the bridge that is the structure 140, in the display field of the image orientation guide information. Furthermore, the control unit 1176 converts information displayed in the display field of the image orientation guide information into voice and outputs from the voice output unit 115. For example, the control unit 176 outputs a guide message such as “the lateral direction of the captured image is parallel to the bridge axis direction”, or “the lateral direction of the captured image is perpendicular to the bridge axis direction”, or “the lateral direction of the captured image tilts 45 degrees clockwise with reference to the bridge axis direction”.

The operator can recognize whether or not the position and the capture direction of the camera 130 are appropriate based on the image orientation guide information displayed and output by voice. Moreover, the operator can figure that a difference between the lateral direction of the image captured by the camera 130 and a predetermined direction (the bridge axis direction) is, for example, a difference of about 45 degrees clockwise, based on the image orientation guide information displayed and output by voice. Finally, the operator adjusts the capture direction of the camera 130 by the pan head 151 so that the orientation of the image captured by the camera 130 is a predetermined orientation by reference to the image orientation guide information. For example, the operator adjusts so that the lateral direction of the captured image becomes parallel to the bridge axis.

Upon finishing adjustment of the position and the capture direction of the camera 130, the operator pushes the registration button in the case of registering information of the position and the capture direction. The operator pushes the diagnosis button in the case of executing a diagnosis in the adjusted position and in the adjusted capture direction. In the case of finishing the first diagnosis, the operator pushes the end button. When the control unit 1176 detects that the end button is pushed (step S14), the control unit 1176 ends the processing shown in FIG. 7.

Further, when the control unit 1176 detects that the registration button is pushed (step S12), the control unit 1176 creates new diagnosis spot information 11661 and registers into the diagnosis spot database 1166 (step S15). The current position of the camera 130 and the current time are acquired from the GPS receiver 132 by the capture position acquisition unit 1171 and stored as the capture position 1162 in the storage unit 116. The capture direction of the camera 130 is calculated by the capture direction acquisition unit 1172 based on the orientation acquired from the orientation sensor 133 and the accelerations acquired from the acceleration sensor 134 and stored as the capture direction 1163 in the storage unit 116. The image being captured by the camera 130 is acquired from the camera 130 by the captured image acquisition unit 1173 and stored as the time-series image 1164 in the storage unit 116. The control unit 1176 acquires the capture position 1162, the capture direction 1163, and the time-series image 1164 from the storage unit 116, creates the diagnosis spot information 11661 based on the abovementioned information, and registers into the diagnosis spot database 1166. At this time, the control unit 1176 sets a newly numbered ID to the diagnosis spot ID 11662 of the diagnosis spot information 11661, and sets the current time to the registration date and time 11663.

Further, when the control unit 1176 detects that the diagnosis button is pushed (step S13), the control unit 1176 activates the diagnostic unit 115 to execute a diagnosis (step S16). For example, as mentioned before, the diagnostic unit 1175 analyzes a video obtained by high-speed image capture of the region 141 of the structure 140 by the camera 130, measures the vibrations of the surface, and estimates an internal deterioration status such as a crack, exfoliation and a cavity from the pattern of the vibrations. Then, the diagnostic unit 1175 stores information relating to the estimated diagnosis result into the diagnosis result database 1167. The control unit 1176 retrieves the result of the diagnosis by the diagnostic unit 1175 from the diagnosis result database 1167, displays on the screen display unit 114, or/and outputs to an external terminal through the communication I/F/unit 112 (step S17).

### <Continued Diagnosis>

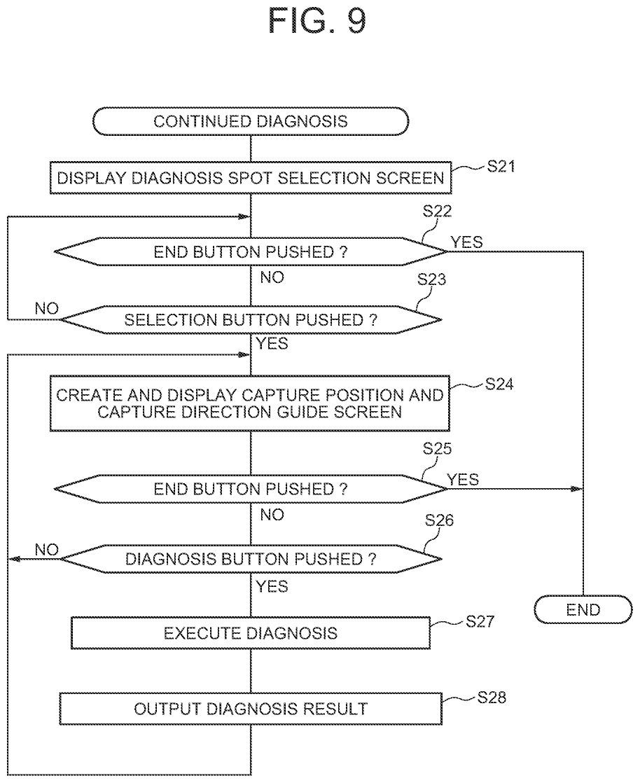

When the operator pushes the continued diagnosis button on the initial screen, the control unit 1176 detects that (step S4), and executes continued diagnosis processing (step S5). FIG. 9 is a flowchart showing an example of the continued diagnosis processing. First, the control unit 1176 displays a diagnosis spot selection screen on the screen display unit 114 (step S21).

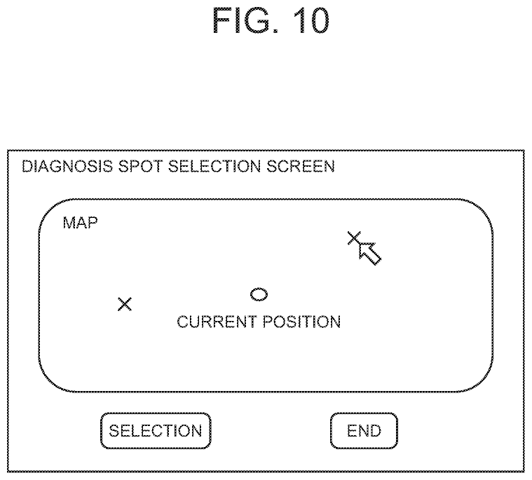

FIG. 10 shows an example of the diagnosis spot selection screen. The diagnosis spot selection screen in this example includes a map, a selection button, and an end button. On the map, a current position icon (a circle mark in the figure) indicating the current position of the camera 130 and a past position icon (a cross mark in the figure) indicating a past capture position are displayed. The control unit 1176 searches the diagnosis spot database 1166 with the current position of the camera 130 as a key, and thereby acquires the diagnosis spot information 11661 that includes a position within a predetermined distance from the current position in the capture position 11664 from the diagnosis spot database 1166. Then, the control unit 1176 displays the past position icon in the position indicated by the capture position 11664 of the acquired diagnosis spot information 11661. In the case of performing a diagnosis on the same spot as the past diagnosis spot, the operator places a mouse cursor at a desired past position icon and pushes the selection button. In the case of finishing selection of a diagnosis spot, the operator pushes the end button. When the control unit 1176 detects that the end button is pushed (step S22), the control unit 1176 ends the processing shown in FIG. 9.

Further, when the control unit 1176 detects that the selection button is pushed (step S23), the control unit 1176 creates a capture position and capture direction guide screen based on the diagnosis spot information 11661 corresponding to the selected past position icon, and displays on the screen display unit 114 (step S24).

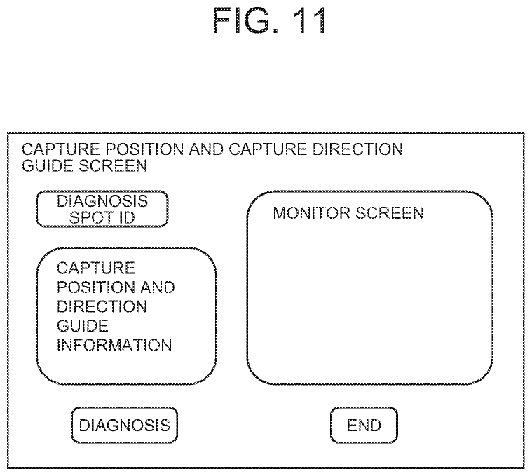

FIG. 11 shows an example of the capture position and capture direction guide screen. The capture position and capture direction guide screen in this example includes a monitor screen, a display field for diagnosis spot ID, a display field for capture position and capture direction guide information, a diagnosis button, and an end button. The monitor screen displays to monitor the image captured by the camera 130. The display field for capture position and capture direction guide information displays information relating to a difference in position between the position of the camera 130 and the position of the camera 130 at the time of capturing a registration captured image and a difference in direction between the image capture direction of the camera 130 and the image capture direction of the camera 130 at the time of capturing the registration captured image. The control unit 1176 converts the information displayed in the display field for capture position and capture direction guide information into voice and outputs from the voice output unit 115. For example, the control unit 1176 outputs a guide message such as “both the position and the image capture direction are good”, “please move back because the position is too close”, “please move left because the position is rightward”, or “please turn left because the capture direction is rightward”.

The operator can recognize whether or not the position and the capture direction of the camera 130 are appropriate based on the capture position and the capture direction guide information displayed and output by voice. Moreover, the operator can determine how to change the position and the capture direction of the camera 130 based on the capture position and capture direction guide information displayed and output by voice.

After displaying the capture position and capture direction guide screen, the control unit 1176 detects whether the end button is pushed (step S25) and detects whether the diagnosis button is pushed (step s26) and, if either button is not pushed, returns to step S24. Therefore, when the position and the capture direction of the camera 130 are changed by the operator, the capture position and capture direction guide screen is created and drawn again in accordance with the change. Then, when the diagnosis button is pushed, the control unit 1176 activates the diagnostic unit 1175 to execute a diagnosis (step S27). When the diagnosis by the diagnostic unit 1175 is finished, the control unit 1176 retrieves the result of the diagnosis by the diagnostic unit 1176 from the diagnosis result database 1167, displays on the screen display unit 114, or/and outputs to an external terminal through the communication I/F unit 112 (step S28). Then, the control unit 1176 returns to step S24. On the other hand, when the end button is pushed, the control unit 1176 finishes the processing shown in FIG. 9.

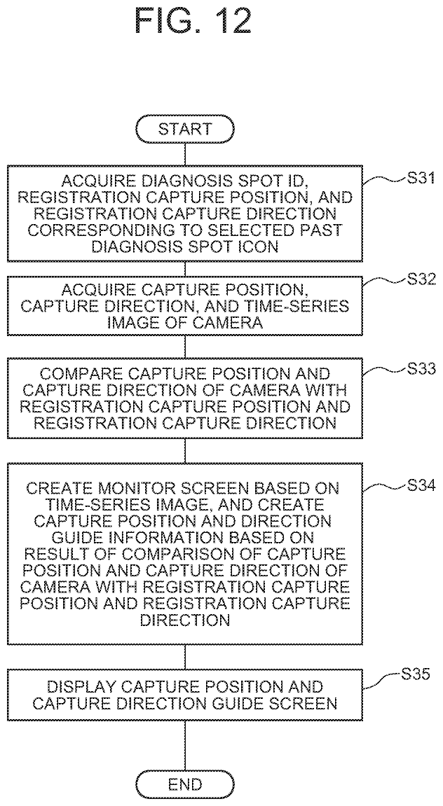

FIG. 12 is a flowchart showing the details of step S24 of FIG. 8. First, the control unit 1176 acquires the diagnosis spot ID, the registration capture position, and the registration capture direction from the diagnosis spot information 11661 corresponding to the selected past position icon (step S31). Next, the control unit 1176 acquires the capture position 1162, the capture direction 1163, and the time-series image 1164 from the storage unit 116 (step S32). Next, the control unit 1176 compares the capture position 1162 and the capture direction 1163 with the registration capture position and the registration capture direction, and detects a difference in position and a difference in direction between the both (step S33). Next, the control unit 1176 creates a monitor screen based on the time-series image 1164, and creates capture position and capture direction guide information based on the difference in position and the difference in direction detected at step S33 (step S34). Next, the control unit 1176 composes the capture position and capture direction guide screen from the monitor screen and the capture position and capture direction guide information created above and another screen element, and displays on the display unit 114 (step S35).

As described above, in the capture position and capture direction guide information, information of a difference between the position of the camera 130 detected by the GPS receiver 132 and the registration capture position is displayed. Moreover, in the capture position and capture direction guide information, information of a difference between the capture direction of the camera 130 calculated based on the orientation detected by the orientation sensor 133 and the accelerations detected by the acceleration sensor 134 and the registration capture direction is displayed. With such information, the operator can adjust the position and the capture direction of the camera 130 to the same camera position and capture direction as those in the first diagnosis. Therefore, if the operator adjusts the lateral direction of the image captured by the camera so as to be parallel to the bridge axis direction at the time of the first diagnosis, the operator can adjust the orientation of the image captured by the camera so as to be the same as the orientation in the first diagnosis at the time of second and subsequent diagnoses.

Subsequently, a configuration example of the image orientation determination unit 1174 will be described.

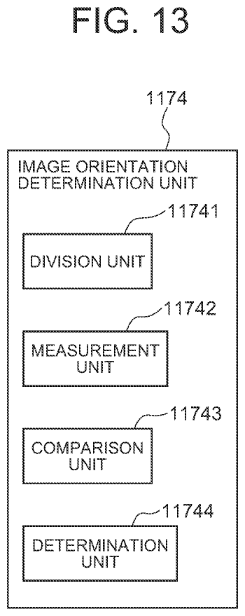

FIG. 13 is a block diagram showing an example of the image orientation determination unit 1174. Referring to FIG. 13, the image orientation determination unit 1174 includes a division unit 11741, a measurement unit 11742, a comparison unit 11743, and a determination unit 11744.

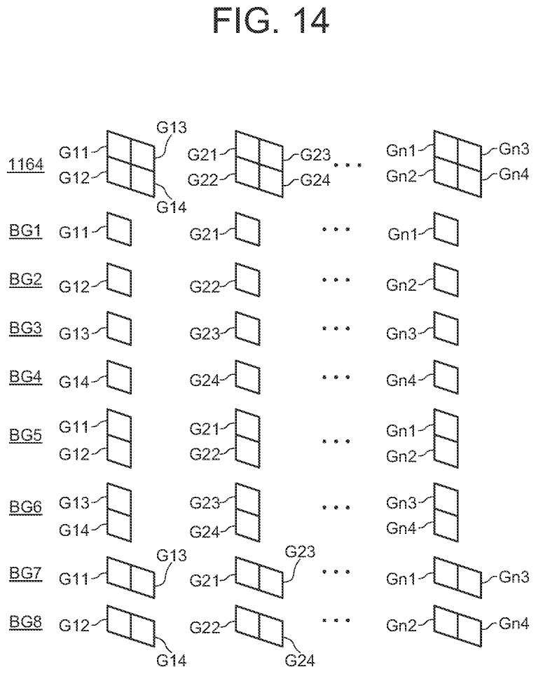

The division unit 11741 is configured to spatially divide the time-series image 1164 obtained by capturing the region 141 of the structure 140 into a plurality of regions to generate a plurality of partial time-series images corresponding to a plurality of partial regions. FIG. 14 is a view showing an example of a relation between the time-series image 1164 before division and the partial time-series images after division. In this example, the time-series image 1164 before division is composed of n frame images arranged in chronological order. The frame image is divided into four equal parts; an upper left block, a lower left block, an upper right block, and a lower right block. Each of the upper left block, the lower left block, the upper right block, and the lower right block constitutes one partial region. Moreover, a block that combines the upper left block and the lower left block is referred to as a left-side block, a block that combines the upper right block and the lower right block is referred to as a right-side block, a block that combines the upper left block and the upper right block is referred to as an upper-side block, and a block that combines the lower left block and the lower right block is referred to as a lower-side block. Each of the left-side block, the right-side block, the upper-side block, and the lower-side block constitutes one partial region.

There are eight partial time-series images after division in total. One partial time-series image is composed of a set of n partial frame images in which the upper left blocks are arranged in chronological order (this partial time-series image is referred to as an upper left partial time-series image BG1). Another partial time-series image is composed of a set of n partial frame images in which the lower left blocks are arranged in chronological order (this partial time-series image is referred to as a lower left partial time-series image BG2). Another partial time-series image is composed of a set of n partial frame images in which the upper right blocks are arranged in chronological order (this partial time-series image is referred to as an upper right partial time-series image BG3). Another partial time-series image is composed of a set of n partial frame images in which the lower right blocks are arranged in chronological order (this partial time-series image is referred to as a lower right partial time-series image BG4). Another partial time-series image is composed of a set of n partial frame images in which the left-side blocks are arranged in chronological order (this partial time-series image is referred to as a left-side partial time-series image BG5). Another partial time-series image is composed of a set of n partial-frame images in which the right-side blocks are arranged in chronological order (this partial time-series image is referred to as a right-side partial time-series image BG6). Another partial time-series image is composed of a set of n partial frame images in which the upper-side blocks are arranged in chronological order (this partial time-series image is referred to as an upper-side partial time-series image BG7). The last one partial time-series image is composed of a set of n partial frame images in which the lower-side blocks are arranged in chronological order (this partial time-series image is referred to as a lower-side partial time-series image BG8).

The measurement unit 11742 is configured to measure a temporal change in deflection amount of the surface of the structure 140 from each of the partial regions of the partial time-series images generated by the division unit 1141. In a case where the deck of a bridge is captured from below with a camera, an image capture length L between the camera and the deck is shortened by a deflection amount δ generated at the deck of the bridge due to a traffic load. Consequently, a captured image is magnified around the optical axis of the camera, and an apparent displacement δᵢ due to deflection occurs. Assuming an image capture length is L, a displacement is δᵢ, a deflection amount is δ, the distance from a camera optical axis to a displacement calculation position is x, and the focal length of the camera is f, a relation of δᵢ=xf{1/(L−δ)−1/L} is established. Therefore, by detecting the displacement δᵢ for each of the frames of the partial regions by a digital image correlation method or the like, it is possible to calculate a deflection amount for each of the frames of the partial regions from the above equation. The image capture length L can be measured in advance, for example, by a laser range finder, the distance x can be obtained from the displacement calculation position of the image before division and the camera optical axis, and f is known for each image capture device.

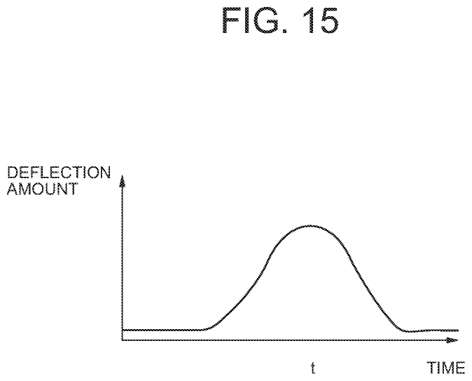

FIG. 15 is a schematic view showing an example of a temporal change in deflection amount of one of the partial regions of the partial time-series images. The vertical axis takes a deflection amount, and the horizontal axis takes a time. In this example, an initial deflection amount is almost zero, and thereafter, the deflection amount gradually increases and reaches its maximum at time t, and thereafter, the deflection amount gradually decreases and returns to zero again. Such a characteristic is obtained when one vehicle passes directly above or in the vicinity of the partial region within a time from the first image frame to the last image frame of the time-series image.

The comparison unit 11743 is configured to compare temporal changes in deflection amount of the surface of the structure 140 for each partial region measured by the measurement unit 11742 between different partial regions. As a method of comparing temporal changes of deflection amounts of two partial regions, a method of obtaining a difference between the deflection amounts of both the partial regions at the same time is used in this example embodiment. That is to say, assuming deflection amounts at times t1, t2, . . . , tn of one partial region are M1, M2, . . . , Mn, and deflection amounts at the times t1, t2, . . . , tn of the other one partial region are δ21, δ22, . . . , δ2n, differences between the deflection amounts at the times t1, t2, . . . , tn are calculated as δ11-δ21, δ12-δ22, . . . , δn1-δn2. In this example embodiment, partial regions to be compared with each other are the following four combinations:
(A) a combination of the left-side block and the right-side block (this combination is referred to as a combination A;
(B) a combination of the upper-side block and the lower-side block (this combination is referred to as a combination B;
(C) a combination of the upper left block and the lower right block (this combination is referred to as a combination C); and
(D) a combination of the lower left block and the upper right block (this combination is referred to as a combination D).

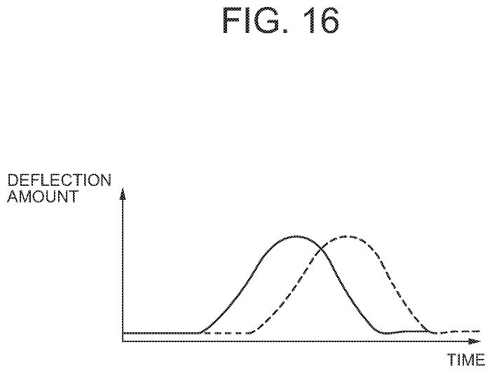

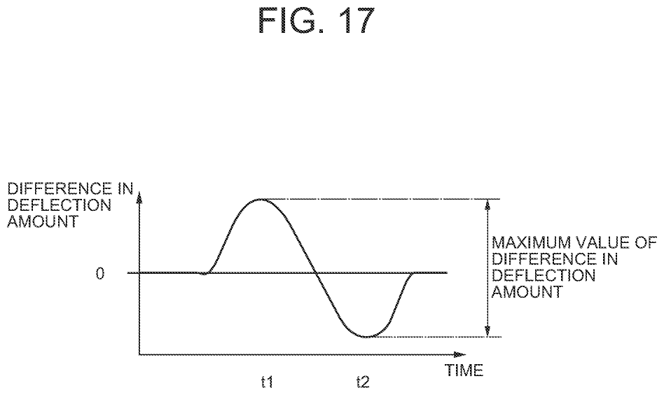

FIG. 16 shows an example of a graph showing an example of temporal changes of deflection amounts of two partial regions. FIG. 17 shows an example of a graph showing an example of a temporal change of a difference between deflection amounts of two partial regions. A temporal change of a deflection amount of one partial region is shown by a solid line of the graph of FIG. 16, and a temporal change of a deflection amount of the other partial region is shown by a broken line of the graph of FIG. 16. In that case, a temporal change of a difference between the deflection amounts of both the partial regions obtained by subtracting the deflection amount of the other partial region from the deflection amount of the one partial region is shown by a solid line of the graph of FIG. 17. In the illustrated example, the difference between the deflection amounts is initially zero, gradually increases in the positive direction to reach its maximum at the time t1, and thereafter, gradually decreases to reach its minimum at the time t2, and thereafter, gradually comes close to zero. A value obtained by adding the absolute values of the maximum value and the minimum value of the difference between the deflection amounts is defined as the maximum value of the difference between the deflection amounts.

The determination unit 11744 is configured to determine the orientation of a captured image with respect to the passing direction of a traffic load based on the result of the comparison in each of the combinations by the comparison unit 11743. Since a vehicle moves in the bridge axis direction, the passing direction of the traffic load matches the bridge axis direction. In this example embodiment, the determination unit 11744 determines whether or not the lateral direction of a captured image is parallel to the bridge axis direction and whether or not the lateral direction is perpendicular to the bridge axis direction. In a case where the lateral direction of the captured image is not either parallel or vertical, the determination unit 11744 determines to what degree the lateral direction of the captured image tilts with respect to the bridge axis direction.

For example, when the maximum value of a difference in deflection amount of the combination A is equal to or more than a predetermined threshold value THmax and the maximum value of a difference in deflection amount of the combination B is equal to or less than a predetermined threshold value THmin (<THmax) (this condition will be referred to as a condition 1 hereinafter), the determination unit 11744 determines that the lateral direction of a captured image is parallel to the bridge axis direction. The threshold value THmin is set to 0 or a positive value close to 0. The threshold value THmax is set to, for example, the maximum deflection amount of the deck observed when only one vehicle (for example, private vehicle) passes through the bridge. However, the threshold values THmin and THmax are not limited to the above examples. Moreover, the threshold values THmin and THmax may be fixed values, or may be variable values that change in accordance with the situation of each structure. The reason for determining in the above manner will be described below.

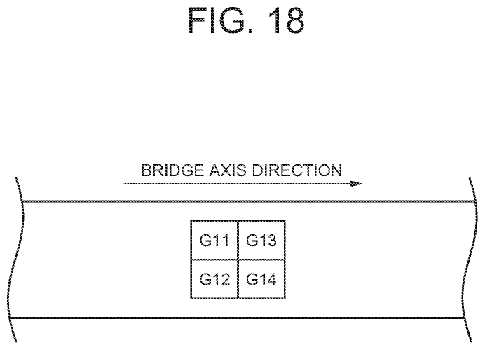

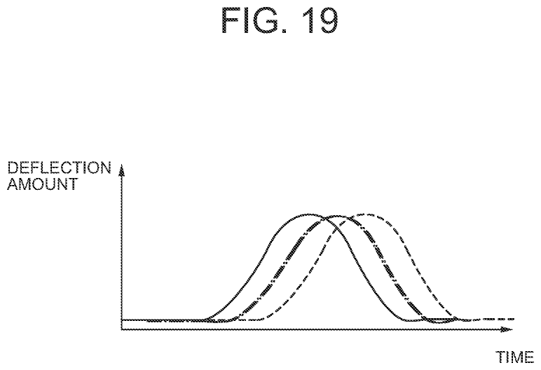

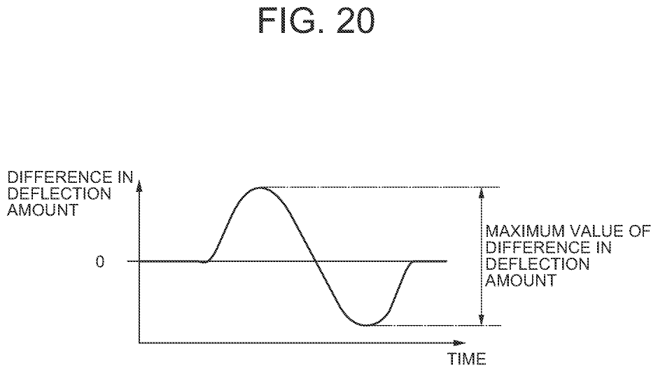

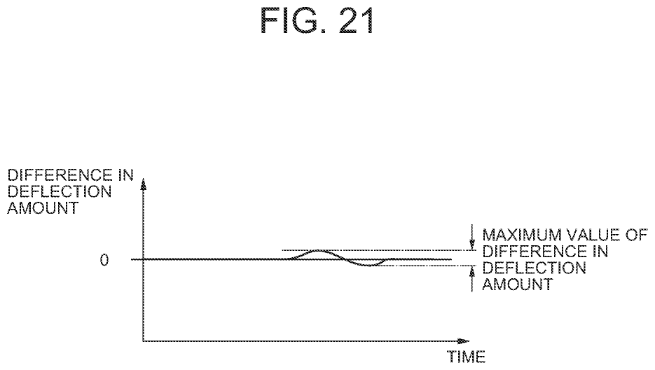

When the lateral direction of a captured image is parallel to the bridge axis direction, for example, as shown in FIG. 18, the left-side block (G11, G12) and the right-side block (G13, G14) of the combination A are arranged so as to be parallel to the bridge axis direction, and the upper-side block (G11, G13) and the lower-side block (G12, G14) of the combination B are arranged so as to be perpendicular to the bridge axis direction. Since a vehicle passing through the bridge moves parallel to the bridge axis direction, temporal changes of the deflection amounts of the left-side block and the right-side block temporarily deviate from each other, for example, as shown by a solid line and a broken line of the graph of FIG. 19. Therefore, a temporal change in difference between the deflection amounts of the two blocks has a characteristic as shown by a solid line of the graph of FIG. 20, and the maximum value of the difference between the deflection amounts becomes equal to or more than the threshold value THmax. On the other hand, temporal changes of the deflection amounts of the upper-side block and the lower-side block are equal to each other, for example, as shown by a dashed-dotted line of the graph of FIG. 19. Therefore, a temporal change in difference between the deflection amounts of the two blocks becomes almost zero and has a characteristic as shown by a solid line of the graph of FIG. 21. As a result, the maximum value of the difference between the deflection amounts becomes equal to or less than the threshold value THmin.

Further, when the maximum value of a difference in deflection amount of the combination B is equal to or more than the threshold value THmax and the maximum value of a difference in deflection amount of the combination A is equal to or less than the threshold value THmin (this condition will be referred to as a condition 2 hereinafter), the determination unit 11744 determines that the lateral direction of a captured image is perpendicular to the bridge axis direction. The reason for determining in the above manner is as follows.

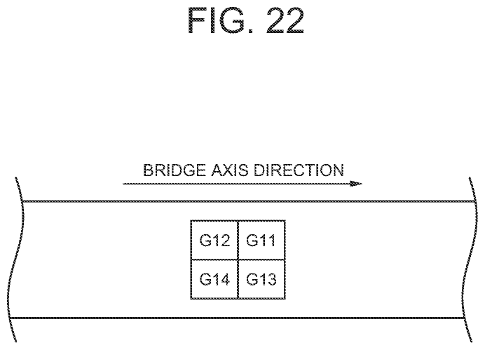

When the lateral direction of a captured image is perpendicular to the bridge axis direction, for example, as shown in FIG. 22, the upper-side block (G11, G13) and the lower-side block (G12, G14) of the combination B are arranged so as to be parallel to the bridge axis direction, and the left-side block (G11, G12) and the right-side block (G13, G14) of the combination A are arranged so as to be perpendicular to the bridge axis direction. Since a vehicle passing through the bridge moves parallel to the bridge axis direction, temporal changes of deflection amounts of the upper-side block and the lower-side block temporarily deviate from each other as shown by the solid line and the broken line of the graph of FIG. 19. Therefore, a temporal change in difference between the deflection amounts of the two blocks is as shown by the solid line of the graph of FIG. 20, and the maximum value of the difference between the deflection amounts is equal to or more than the threshold value THmax. On the other hand, temporal changes of deflection amounts of the left-side block and the right-side block are almost equal to each other, for example, as shown by the dashed-dotted line of the graph of FIG. 19. Therefore, a temporal change in difference between the deflection amounts of the two blocks is as shown by the solid line of the graph of FIG. 21, and the maximum value of the difference between the deflection amounts is equal to or less than the threshold value THmin.

In a case where either the condition 1 or the condition 2 is not established, the determination unit 11744 determines that the lateral direction of the captured image is not either parallel to or perpendicular to the bridge axis direction. Moreover, in the case of thus determining, the determination unit 11744 determines to what degree the lateral direction of the captured image tilts with respect to the bridge axis direction.

For example, when the maximum value of a difference in deflection amount of the combination D is equal to or more than the threshold value THmax and the maximum value of a difference in deflection amount of the combination C is equal to or less than the threshold value THmin (this condition will be referred to as a condition 3), the determination unit 11744 determines that the lateral direction of a captured image tilts 45 degrees clockwise with respect to the bridge axis direction. The reason for determining in the above manner is as follows.

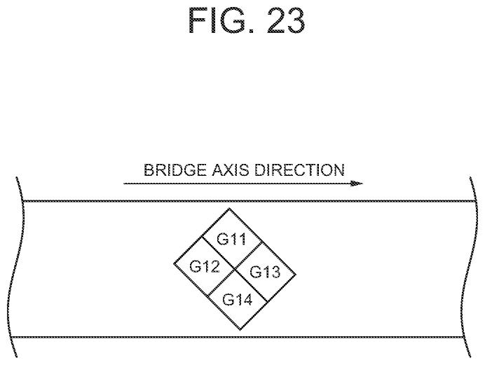

When the lateral direction of a captured image tilts 45 degrees clockwise with respect to the bridge axis direction, for example, as shown in FIG. 23, the lower left block G12 and the upper right block G13 of the combination D are arranged so as to be parallel to the bridge axis direction, and the upper left block Gil and the lower right block G14 of the combination C are arranged so as to be perpendicular to the bridge axis direction. Since a vehicle passing through the bridge moves parallel to the bridge axis direction, temporal changes of deflection amounts of the lower left block G12 and the upper right block G13 temporarily deviate from each other, for example, as shown by the solid line and the broken line of the graph of FIG. 19. Therefore, a temporal change in difference between the deflection amounts of the two blocks is as shown in FIG. 20, and the maximum value of the difference between the deflection amounts is equal to or more than the threshold value THmax. On the other hand, temporal changes of deflection amounts of the upper left block Gil and the lower right block G14 are almost equal to each other, for example, as shown by the dashed-dotted lines of the graph of FIG. 19. Therefore, a temporal change in difference between the deflection amounts of the two blocks is as shown by the solid line of the graph of FIG. 21, and the maximum value of the difference between the deflection amounts is equal to or less than the threshold THmin.

Further, when the maximum value of a difference in deflection amount of the combination C is equal to or more than the threshold value THmax and the maximum value of a difference in deflection amount of the combination D is equal to or less than the threshold value THmin (this condition will be referred to as a condition 4 hereinafter), the determination unit determines that the lateral direction of a captured image tilts 45 degrees counterclockwise with respect to the bridge axis direction. The reason for determining in the above manner is as follows.

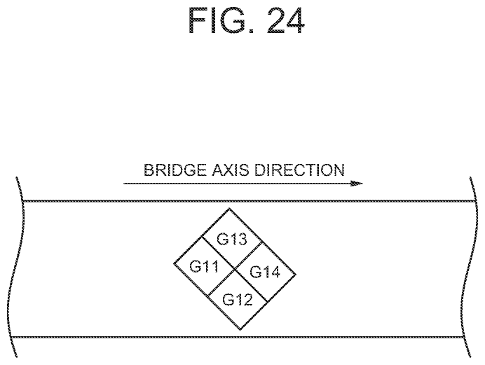

When the lateral direction of a captured image tilts 45 degrees counterclockwise with respect to the bridge axis direction, for example, as shown in FIG. 24, the upper left block G11 and the lower right block G14 of the combination C are arranged so as to be parallel to the bridge axis direction, and the lower left block G12 and the upper right block G13 of the combination D are arranged so as to be perpendicular to the bridge axis direction. Since a vehicle passing through the bridge moves parallel to the bridge axis direction, temporal changes of deflection amounts of the upper left block G11 and the lower right block G14 temporarily deviate from each other, for example, as shown by the solid line and the broken line of the graph of FIG. 19. Therefore, a temporal change in difference between the deflection amounts of the two blocks is as shown by the solid line of the graph of FIG. 20, and the maximum value of the difference between the deflection amounts is equal to or more than the threshold value THmax. On the other hand, temporal changes of deflection amounts of the lower left block G12 and the upper right block G13 are almost equal to each other, for example, as shown by the dashed-dotted lines of the graph of FIG. 19. Therefore, a temporal change in difference between the deflection amounts of the two blocks is as shown by the solid line of the graph of FIG. 21, and the maximum value of the difference between the deflection amounts is equal to or less than the threshold value THmin.

Further, in a case where any of the conditions 1 to 4 is not established, the determination unit 11744 compares the maximum value of the difference between the deflection amounts of the combination A with the maximum value of the difference between the deflection amounts of the combination B, and determines which is larger. Next, in a case where the maximum value of the difference between the deflection amounts of the combination A is larger than the maximum value of the difference between the deflection amounts of the combination B (this condition will be referred to as a condition 5 hereinafter), the determination unit 11744 determines that the lateral direction of the captured image tilts within ±45 degrees with respect to the bridge axis direction. The reason is that the maximum value of the difference between the deflection amounts of the combination A becomes more than the maximum value of the difference of the deflection amounts of the combination B either when the blocks G11 to G14 are in any state up to the state shown in FIG. 23 rotated 45 degrees clockwise from the state shown in FIG. 18 or when the blocks G11 to G14 are in any state up to the state shown in FIG. 24 rotated 45 degrees counterclockwise from the state shown in FIG. 18. On the other hand, in a case where the maximum value of the difference between the deflection amounts of the combination B is more than the maximum value of the difference between the deflection amounts of the combination A (this condition will be referred to as a condition 6 hereinafter), the determination unit 11744 determines that the lateral direction of the captured image tilts within ±45 degrees with respect to a direction perpendicular to the bridge axis direction.

Further, in a case where the condition 5 is established, the determination unit 11744 compares the maximum value of the difference between the deflection amounts of the combination C with the maximum value of the difference between the deflection amounts of the combination D. Then, in a case where the maximum value of the difference between the deflection amounts of the combination C is more than the maximum value of the difference between the deflection amounts of the combination D, the determination unit 11744 determines that the lateral direction of the captured image tilts within 45 degrees counterclockwise with respect to the bridge axis direction. The reason is that the maximum value of the difference between the deflection amounts of the combination C becomes more than the maximum value of the difference between the deflection amounts of the combination D when the blocks Gil to G14 are in any state up to the state shown in FIG. 24 rotated 45 degrees counterclockwise from the state shown in FIG. 18. Moreover, in a case where the maximum value of the difference between the deflection amounts of the combination D is more than the maximum value of the difference between the deflection amounts of the combination C, the determination unit 11744 determines that the lateral direction of the captured image tilts within 45 degrees clockwise with respect to the bridge axis direction.

Further, in a case where the condition 6 is established, the determination unit 11744 compares the maximum value of the difference between the deflection amounts of the combination C with the maximum value of the difference between the deflection amounts of the combination D. Then, in a case where the maximum value of the difference between the deflection amounts of the combination C is more than the maximum value of the difference between the deflection amounts of the combination D, the determination unit 11744 determines that the lateral direction of the captured image tilts within 45 degrees clockwise with respect to the direction perpendicular to the bridge axis direction. Moreover, in a case where the maximum value of the difference between the deflection amounts of the combination D is more than the maximum value of the difference between the deflection amounts of the combination C, the determination unit 11744 determines that the lateral direction of the captured image tilts within 45 degrees counterclockwise with respect to the direction perpendicular to the bridge axis direction.

The above is an example of the image orientation determination unit 1174.

In the above description, the image orientation determination unit 1174 divides the entire frame image into four equal parts. However, the method of dividing the frame image into a plurality of blocks is not limited to the above. For example, instead of the entire frame image, a part of the image, such as a central part excluding a peripheral part, may be divided into a plurality of blocks. Moreover, each divided block does not need to be in contact with another block. Moreover, the number of divisions is not limited to four, and may be a number less than four, that is, two or three, or may be a number more than four.

Further, the combination of partial regions whose temporal changes in deflection amount are compared with each other is not limited to the above example. For example, instead of the combination of the left-side block and the right-side block, the combination of the upper left block and the upper right block, or the combination of the lower left block and the lower right block may be used. Moreover, instead of the combination of the upper-side block and the lower-side block, the combination of the upper left block and the lower left block, or the combination of the upper right block and the lower right block may be used.

Further, in order to compare temporal changes in deflection amount of two partial regions, the comparison unit 11743 compares the deflection amount of one partial region with the deflection amount of the other partial region at the same time, and obtain the difference between the deflection amounts of the two partial regions. However, the comparison method is not limited to the above method. For example, assuming a temporal change pattern of the deflection amount of one partial region as a first change pattern and a temporal change pattern of the deflection amount of the other partial region as a second change pattern, the comparison unit 11743 may calculate the minimum value of a shift time with respect to the first change pattern required for the first change pattern and the second change pattern to match the best, as the maximum value of the difference between the deflection amounts described above.

As described above, according to this example embodiment, even if an image of the deck of a bridge captured from below does not show a subject that allows specification of the orientation of the image, the orientation of the image can be determined from the image. The reason is that a time-series image captured while a traffic load is passing a bridge is spatially divided into a plurality of partial regions to generate a plurality of partial time-series images, temporal changes in deflection amount of the bridge for the respective partial regions are measured from the plurality of partial time-series images, the temporal changes in deflection amount of the bridge for the respective partial regions are compared, and the orientation of the image with respect to a direction in which the traffic load is passing is determined.

Further, according to this example embodiment, since the determined orientation of the image is notified to the operator visually or by voice, the operator can correctly adjust an image of a camera capturing a region to be a diagnosis spot of the bridge in a predetermined direction, that is, in a direction parallel to or perpendicular to the bridge axis.

Further, in the above description, the result of determining the orientation of the image captured by the camera 130 is presented to the operator. However, the orientation of a captured image determined by the present invention can be used for various purposes other than presenting to the operator. For example, the control unit 1176 causes the image orientation determination unit 1174 to determine the image orientation of the registration time-series image 11666 recorded in the diagnosis spot database 1166 shown in FIG. 2, changes the image orientation of the registration time-series image 11666 so as to be unified to a predetermined orientation (for example, an orientation that the lateral direction of the image is parallel to the bridge), and align the orientations of all the registration time-series images 11666 in the diagnosis spot information 11661 to the predetermined orientation after the fact. At this time, the control unit 1176 functions as an aligning unit.

### Second Example Embodiment

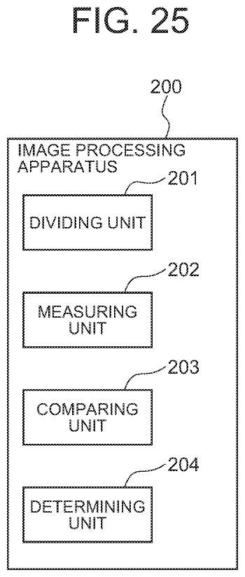

Next, a second example embodiment of the present invention will be described with reference to FIG. 25. FIG. 25 is a block diagram of an image processing apparatus according to this example embodiment. This example embodiment describes the outline of the image processing apparatus of the present invention.

Referring to FIG. 25, an image processing apparatus 200 according to this example embodiment includes a dividing unit 201, a measuring unit 202, a comparing unit 203, and a determining unit 204.

The dividing unit 201 is configured to spatially divide a time-series image of the surface of a structure captured while a traffic load is passing into a plurality of partial regions to generate a plurality of partial time-series images. The dividing unit 201 can be configured, for example, in the same manner as the division unit 117 shown in FIG. 13, but is not limited thereto.

The measuring unit 202 is configured to measure temporal changes in deflection amount of the structure for the respective partial regions from the plurality of partial time-series images generated by the dividing unit 201. The measuring unit 202 can be configured, for example, in the same manner as the measurement unit 11742 shown in FIG. 13, but is not limited thereto.

The comparing unit 203 is configured to compare the temporal changes in deflection amount of the structure for the respective partial regions measured by the measuring unit 202. The comparing unit 203 can be configured, for example, in the same manner as the comparison unit 11743 shown in FIG. 13, but is not limited thereto.

The determining unit 204 is configured to determine an orientation of the time-series image with respect to a passing direction of the traffic load based on a result of the comparison by the comparing unit 203. The determining unit 204 can be configured, for example, in the same manner as the determination unit 11744 shown in FIG. 13, but is not limited thereto.

The image processing apparatus 200 thus configured operates in the following manner. The dividing unit 201 spatially divides a time-series image of the surface of a structure captured while a traffic load is passing into a plurality of partial regions to generate a plurality of partial time-series images. Next, the measuring unit 202 measures temporal changes in deflection amount of the structure for the respective partial regions from the plurality of partial time-series images generated by the dividing unit 201. Next, the comparing unit 203 compares the temporal changes in deflection amount of the structure for the respective partial regions measured by the measuring unit 202. Next, the determining unit 204 determines an orientation of the time-series image with respect to a passing direction of the traffic load based on a result of the comparison by the comparing unit 203.

According to this example embodiment, with the configuration and the operation as described above, even if an image obtained by capturing the surface of a structure does not show a subject that allows specification of the orientation of the image, the orientation of the image can be determined from the image. The reason is that, based on a difference between temporal changes in deflection amount of the respective partial regions when a traffic load passes on the surface of a structure, the orientation of an image with respect to a passing direction of the traffic load is determined.

Although the present invention has been described above with reference to the example embodiments, the present invention is not limited to the above example embodiments. The configurations and details of the present invention can be changed in various manners that can be understood by one skilled in the art within the scope of the present invention.

The present invention can be utilized, for example, in the case of determining the orientation of an image obtained by capturing the surface of a structure such as a bridge.

The whole or part of the example embodiments disclosed above can be described as, but not limited to, the following supplementary notes.

### [Supplementary Note 1]

An image processing apparatus comprising:

a dividing unit configured to spatially divide a time-series image of a structure surface captured during passage of a traffic load into a plurality of partial regions, and generate a plurality of partial time-series images;

a measuring unit configured to measure temporal changes in deflection amount of the structure surface in the respective partial regions from the plurality of partial time-series images;

a comparing unit configured to compare the temporal changes in deflection amount of the structure surface in the respective partial regions; and

a determining unit configured to determine an orientation of the time-series image with respect to a passage direction of the traffic load based on a result of the comparison.

### [Supplementary Note 2]

The image processing apparatus according to Supplementary Note 1, further comprising an outputting unit configured to output a result of the determination.

### [Supplementary Note 3]

The image processing apparatus according to Supplementary Note 1 or 2, further comprising an outputting unit configured to detect a difference between the orientation of the time-series image and a predetermined orientation, and output information showing the detected difference.

### [Supplementary Note 4]

The image processing apparatus according to any of Supplementary Notes 1 to 3, further comprising an aligning unit configured to align the time-series image based on a result of the determination.

### [Supplementary Note 5]

The image processing apparatus according to any of Supplementary Notes 1 to 4, wherein the comparing unit is configured to calculate a maximum value of a difference in deflection amount at each time between a deflection amount at each time of the structure surface in one of the partial regions and a deflection amount at each time of the structure surface in another one of the partial regions.

### [Supplementary Note 6]

The image processing apparatus according to any of Supplementary Notes 1 to 4, wherein the comparing unit is configured to calculate a minimum value of a shift time with respect to a first pattern required for the first pattern and a second pattern to match best, the first pattern showing a temporal change in deflection amount of the structure surface in one of the partial regions, the second pattern showing a temporal change in deflection amount of the structure surface in another one of the partial regions.

### [Supplementary Note 7]

An image processing method comprising:

spatially dividing a time-series image of a structure surface captured during passage of a traffic load into a plurality of partial regions, and generating a plurality of partial time-series images;

measuring temporal changes in deflection amount of the structure surface in the respective partial regions from the plurality of partial time-series images;

comparing the temporal changes in deflection amount of the structure surface in the respective partial regions; and

determining an orientation of the time-series image with respect to a passage direction of the traffic load based on a result of the comparison.

### [Supplementary Note 8]

The image processing method according to Supplementary Note 7, comprising outputting a result of the determination.

### [Supplementary Note 9]

The image processing method according to Supplementary Note 7 or 8, comprising detecting a difference between the orientation of the time-series image and a predetermined orientation, and outputting information showing the detected difference.

### [Supplementary Note 10]

The image processing method according to any of Supplementary Notes 7 to 9, comprising aligning the time-series image based on a result of the determination.

### [Supplementary Note 11]

The image processing method according to any of Supplementary Notes 7 to 10, wherein in the comparison, a maximum value of a difference in deflection amount at each time between a deflection amount at each time of the structure surface in one of the partial regions and a deflection amount at each time of the structure surface in another one of the partial regions is calculated.

### [Supplementary Note 12]

The image processing method according to any of Supplementary Notes 7 to 10, wherein in the comparison, a minimum value of a shift time with respect to a first pattern required for the first pattern and a second pattern to match best is calculated, the first pattern showing a temporal change in deflection amount of the structure surface in one of the partial regions, the second pattern showing a temporal change in deflection amount of the structure surface in another one of the partial regions.

### [Supplementary Note 13]

A non-transitory computer-readable recording medium on which a computer program is recorded, the computer program comprising instructions for causing a computer to execute:

a process of spatially dividing a time-series image of a structure surface captured during passage of a traffic load into a plurality of partial regions, and generating a plurality of partial time-series images;

a process of measuring temporal changes in deflection amount of the structure surface in the respective partial regions from the plurality of partial time-series images;

a process of comparing the temporal changes in deflection amount of the structure surface in the respective partial regions; and

a process of determining an orientation of the time-series image with respect to a passage direction of the traffic load based on a result of the comparison.

### DESCRIPTION OF NUMERALS

100 diagnostic apparatus
110 computer
111 camera I/F unit
112 communication I/F unit
113 operation input unit
114 screen display unit
115 voice output unit
116 storage unit
117 arithmetic processing unit
120 cable
130 camera
140 structure
141 partial region
150 tripod
151 pan head
200 image processing apparatus
201 dividing unit
202 measuring unit
203 comparing unit
204 determining unit

What is claimed is:

1. An image processing apparatus comprising:
a memory including program instructions; and
a processor coupled to the memory, wherein the processor is configured to execute the program instructions to,
spatially divide a time-series image of a structure surface captured during passage of a traffic load into a plurality of partial regions, and generate a plurality of partial time-series images;
measure temporal changes in deflection amount of the structure surface in the respective partial regions from the plurality of partial time-series images;
compare the temporal changes in deflection amount of the structure surface in the respective partial regions; and
determine an orientation of the time-series image with respect to a passage direction of the traffic load based on a result of the comparison.

2. The image processing apparatus according to claim 1, wherein the processor is further configured to output a result of the determination.

3. The image processing apparatus according to claim 1, wherein the processor is further configured to detect a difference between the orientation of the time-series image and a predetermined orientation, and output information showing the detected difference.

4. The image processing apparatus according to claim 1, wherein the processor is further configured to align the time-series image based on a result of the determination.

5. The image processing apparatus according to claim 1, wherein in the comparison, a maximum value of a difference in deflection amount at each time between a deflection amount at each time of the structure surface in one of the partial regions and a deflection amount at each time of the structure surface in another one of the partial regions is calculated.

6. The image processing apparatus according to claim 1, wherein in the comparison, a minimum value of a shift time with respect to a first pattern required for the first pattern and a second pattern to match best is calculated, the first pattern showing a temporal change in deflection amount of the structure surface in one of the partial regions, the second pattern showing a temporal change in deflection amount of the structure surface in another one of the partial regions.

7. An image processing method comprising:
spatially dividing a time-series image of a structure surface captured during passage of a traffic load into a plurality of partial regions, and generating a plurality of partial time-series images;
measuring temporal changes in deflection amount of the structure surface in the respective partial regions from the plurality of partial time-series images;
comparing the temporal changes in deflection amount of the structure surface in the respective partial regions; and
determining an orientation of the time-series image with respect to a passage direction of the traffic load based on a result of the comparison.

8. The image processing method according to claim 7, further comprising outputting a result of the determination.

9. The image processing method according to claim 7, further comprising detecting a difference between the orientation of the time-series image and a predetermined orientation, and outputting information showing the detected difference.

10. The image processing method according to claim 7, further comprising aligning the time-series image based on a result of the determination.

11. The image processing method according to claim 7, wherein in the comparison, a maximum value of a difference in deflection amount at each time between a deflection amount at each time of the structure surface in one of the partial regions and a deflection amount at each time of the structure surface in another one of the partial regions is calculated.

12. The image processing method according to claim 7, wherein in the comparison, a minimum value of a shift time with respect to a first pattern required for the first pattern and a second pattern to match best is calculated, the first pattern showing a temporal change in deflection amount of the structure surface in one of the partial regions, the second pattern showing a temporal change in deflection amount of the structure surface in another one of the partial regions.

13. A non-transitory computer-readable recording medium on which a computer program is recorded, the computer program comprising instructions for causing a computer to execute:
a process of spatially dividing a time-series image of a structure surface captured during passage of a traffic load into a plurality of partial regions, and generating a plurality of partial time-series images;
a process of measuring temporal changes in deflection amount of the structure surface in the respective partial regions from the plurality of partial time-series images;
a process of comparing the temporal changes in deflection amount of the structure surface in the respective partial regions; and
a process of determining an orientation of the time-series image with respect to a passage direction of the traffic load based on a result of the comparison.
